(19) United States
(12) Patent Application Publication
(10) Pub. No.: US 2021/0224153 A1
(43) Pub. Date: Jul. 22, 2021

(54) INFORMATION PROCESSING APPARATUS, MEMORY CONTROL DEVICE, AND NON-TRANSITORY COMPUTER-READABLE STORAGE MEDIUM FOR STORING MEMORY CONTROL PROGRAM

(71) Applicant: FUJITSU LIMITED, Kawasaki-shi (JP)

(72) Inventor: Satoshi Kazama, Kawasaki (JP)

(73) Assignee: FUJITSU LIMITED, Kawasaki-shi (JP)

(21) Appl. No.: 17/141,255

(22) Filed: Jan. 5, 2021

(30) Foreign Application Priority Data
Jan. 21, 2020 (JP) 2020-007553

(51) Int. Cl. G06F 11/10; G06F 11/30; G06F 12/02

(52) U.S. Cl. CPC G06F 11/1068; G06F 12/0246; G06F 11/3037; G06F 11/1048

(57) ABSTRACT

An information processing apparatus includes: a nonvolatile memory having a plurality of unit storage regions; and a processor coupled to the nonvolatile memory, the processor being configured to: write a check bit, which is a fixed value, at each of a plurality of positions in a single unit storage region; write data to be written to a storage region other than the plurality of positions in the single unit storage region when data is written to the single unit storage region of the plurality of unit storage regions; read the check bits from the single unit storage region; and determine an occurrence status of data corruption in the single unit storage region on the basis of a bit value of each of the read check bits.

### CROSS-REFERENCE TO RELATED APPLICATION

This application is based upon and claims the benefit of priority of the prior Japanese Patent Application No. 2020-7553, filed on Jan. 21, 2020, the entire contents of which are incorporated herein by reference.

### FIELD

The embodiments discussed herein are related to an information processing apparatus, a memory control device, and a non-transitory computer-readable storage medium storing a memory control program.

### BACKGROUND

In recent years, a nonvolatile memory of which an access speed is higher than that of a flash memory has been developed. Examples of such a nonvolatile memory include, for example, a Magnetoresistive Random Access Memory (MRAM), a Resistive RAM (ReRAM), and a Phase Change Memory (PCM). Furthermore, in recent years, a nonvolatile memory (3D crosspoint memory) having a three-dimension (D) crosspoint (3D Xpoint: registered trademark) is productized.

These nonvolatile memories are referred to as Storage aass Memories (SCM) and have attracted attention as a storage device that is replaced with a Solid State Drive (SSD) using a flash memory. However, due to improvement in access performance and advance of reduction in capacity cost, the nonvolatile memory has been started to be used as a storage device that plays at least a part of a role of a main memory in recent years.

On the other hand, in the storage devices, Error Checking and Correction (ECC) is widely used. Regarding the ECC, the following is proposed. For example, a microcomputer is proposed that, in a case where data is read from first and second nonvolatile memories and an error of the data read from the first nonvolatile memory is detected, writes the data read from the second nonvolatile memory to the first nonvolatile memory. Furthermore, a memory device is proposed that provides a success indicator in a case where a page including a plurality of sectors is read from a memory array and each sector includes data of which the number of pieces is within an allowable range in which the data may be corrected using the ECC.

Examples of the related art include Japanese Laid-open Patent Publication No. 2005-339147 and International Publication Pamphlet No. WO 2008/027759.

### SUMMARY

According to an aspect of the embodiments, an information processing apparatus includes: a nonvolatile memory having a plurality of unit storage regions; and a processor coupled to the nonvolatile memory, the processor being configured to: write a check bit, which is a fixed value, at each of a plurality of positions in a single unit storage region; write data to be written to a storage region other than the plurality of positions in the single unit storage region when data is written to the single unit storage region of the plurality of unit storage regions; read the check bits from the single unit storage region; and determine an occurrence status of data corruption in the single unit storage region on the basis of a bit value of each of the read check bits.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration and exemplary processing of an information processing apparatus according to a first embodiment;

FIG. 2 illustrates an exemplary hardware configuration of an information processing apparatus according to a second embodiment;

FIG. 3 illustrates an example of a method of using a Non-Volatile Memory (NVM);

FIG. 4 illustrates an exemplary configuration of processing functions of the information processing apparatus;

FIG. 5 illustrates an example of a graph indicating a relationship between the number of check bits and error rate estimation accuracy;

FIGS. 6A and 6B illustrate examples of a position pattern of the check bits;

FIG. 7 is a diagram for explaining a progress suppression processing pattern 1;

FIG. 8 illustrates an exemplary data configuration of a page management table in a case where the progress suppression processing pattern 1 is adopted;

FIG. 9 is an example of a flowchart illustrating a processing procedure of data writing in a case where the progress suppression processing pattern 1 is adopted;

FIG. 10 is an example of a flowchart illustrating an error rate estimation processing procedure in a case where the progress suppression processing pattern 1 is adopted;

FIG. 11 is an example of a flowchart illustrating a procedure of data corruption progress suppression processing (progress suppression processing pattern 1);

FIG. 12 is an example of a flowchart illustrating a processing procedure of data reading in a case where the progress suppression processing pattern 1 is adopted;

FIG. 13 is a diagram for explaining a progress suppression processing pattern 2;

FIG. 14 illustrates an exemplary data configuration of a page management table in a case where the progress suppression processing pattern 2 is adopted;

FIG. 15 is an example of a flowchart illustrating a processing procedure of data writing in a case where the progress suppression processing pattern 2 is adopted;

FIG. 16 is an example of a flowchart illustrating a procedure of data corruption progress suppression processing (progress suppression processing pattern 2);

FIG. 17 is an example of a flowchart illustrating a processing procedure of data reading in a case where the progress suppression processing pattern 2 is adopted; and

FIG. 18 is a diagram for explaining a progress suppression processing pattern 3.

### DESCRIPTION OF EMBODIMENT(S)

By the way, regarding the above SCM, it has been found that there is a case where a data holding capability is lowered with time and data corruption (bit inversion error) occurs. Therefore, when the SCM is used, it is preferable to determine an occurrence status of the data corruption.

Here, a technology of adding the ECC to the data and recording the data in a memory as described above can detect the data corruption by using the ECC at the time of reading and can correct the data according to the number of bits in which the data corruption occurs. However, ECC creation processing at the time of writing and error detection processing using the ECC at the time of reading need complicated calculations, and it is not possible to be said that these processing is efficient as processing for determination of the data corruption occurrence status. For example, because of the ECC creation processing and the error detection processing using the ECC, a writing speed and a reading speed are reduced. For example, in a case where the SCM plays a part of the role of the main memory as described above, such reduction in the writing speed and the reading speed causes a large problem.

In an aspect of the embodiments, provided is solution to efficiently determine an occurrence status of data corruption in a nonvolatile memory.

Hereinafter, embodiments will be described with reference to the drawings.

### First Embodiment

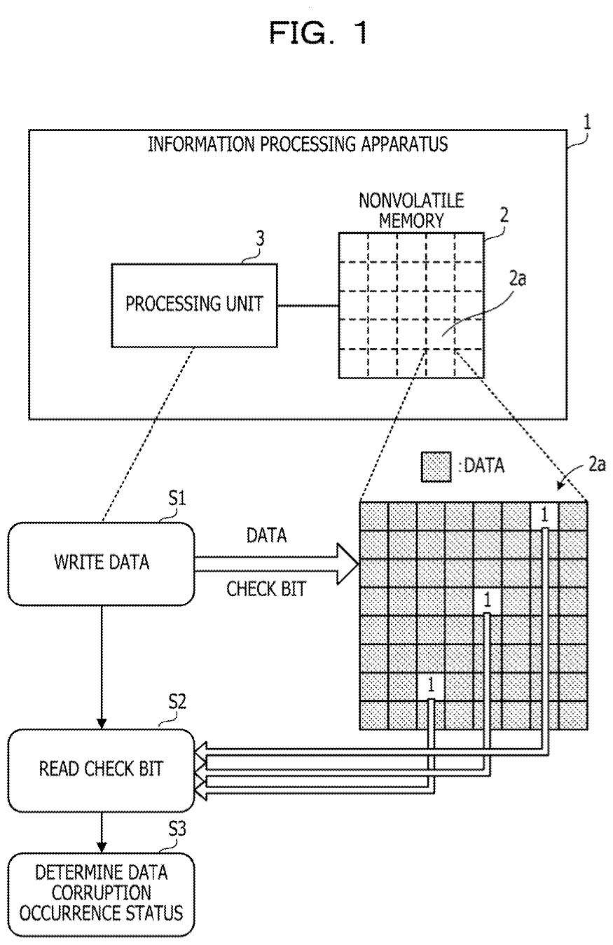

FIG. 1 illustrates an exemplary configuration and exemplary processing of an information processing apparatus according to a first embodiment. An information processing apparatus 1 illustrated in FIG. 1 includes a nonvolatile memory 2 and a processing unit 3.

The nonvolatile memory 2 is realized as a nonvolatile memory generally referred to as an SCM, for example, a 3D crosspoint memory, a MRAM, a ReRAM, a PCM, or the like. Furthermore, the nonvolatile memory 2 has characteristics such that a data holding capability is lowered with time and data corruption (bit inversion error) may occur.

The nonvolatile memory 2 includes a plurality of unit storage regions. In the example in FIG. 1, the nonvolatile memory 2 includes 25 unit storage regions. These unit storage regions are, for example, storage regions to be management units when data is written.

The processing unit 3 controls a data reading/writing operation by using the nonvolatile memory 2. The processing unit 3 is, for example, a processor.

When data is written to each unit storage region of the nonvolatile memory 2, the processing unit 3 executes the following processing. Here, as an example, a case will be described where data is written to a unit storage region 2a of the nonvolatile memory 2. The processing unit 3 writes a check bit, which is a fixed value, at each of a plurality of positions in the unit storage region 2a and writes data to be written to a storage region at a position other than the positions of the check bits in the unit storage region 2a (step S1).

As described later, the check bit is data used to determine an occurrence status of data corruption in the unit storage region. In the example in FIG. 1, check bits having a bit value of “1” are written at three locations on the unit storage region 2a, and data to be written is written to other region in the unit storage region 2a.

Note that, for example, it is sufficient that a predetermined number of check bits be written at predetermined positions in the unit storage region. However, because the check bit is used to determine the occurrence status of data corruption in the unit storage region as described above, it is desirable that the check bits be distributed and written on the unit storage region. Furthermore, the number, the written positions, and the written interval of the check bits may be able to be set for each unit storage region.

After writing the data to the unit storage region 2a in step S1, the processing unit 3 reads each check bit from the unit storage region 2a (step S2). The processing unit 3 determines the occurrence status of data corruption in the unit storage region 2a on the basis of a bit value of each read check bit (step S3). In this determination processing, the occurrence status of data corruption in the entire unit storage region 2a is estimated on the basis of the bit value of each read check bit.

Note that the processing in steps S2 and S3 is repeatedly executed, for example, at regular intervals. Alternatively, the processing in steps S2 and S3 may be executed when data is read from the unit storage region 2a.

Here, as a method of determining the occurrence status of data corruption in the unit storage region, a method of calculating ECC on the basis of data when the data is written to the unit storage region and adding the ECC to the data and writing the data is considered. In this case, the occurrence status of data corruption (for example, the number of bit inversion occurrences) can be determined by reading the data and the ECC from the unit storage region thereafter and performing calculation.

In contrast to such a method, the information processing apparatus 1 in FIG. 1 writes the check bit to the unit storage region when the data is written to the unit storage region. Because the check bit is a fixed value, it is not needed to calculate the check bit like the ECC. Furthermore, the information processing apparatus 1 reads each check bit written to the unit storage region and determines the occurrence status of data corruption on the basis of the bit value of each read check bit. For example, this determination can be made by a more simple procedure compared to a case of using the ECC such as a procedure of counting the number of bits in which data corruption occurs.

Therefore, according to the information processing apparatus 1, the data corruption occurrence status for each unit storage region in the nonvolatile memory 2 can be more efficiently determined compared to a case of using the ECC. For example, according to the information processing apparatus 1, even in a case where a certain number or more check bits are written to each unit storage region and the occurrence status of data corruption is made to be determined with accuracy equal to or higher than a certain degree, a data writing speed to the nonvolatile memory 2 can be increased than a case of using the ECC.

By the way, although the check bit described above has the capability used to determine the occurrence status of data corruption, the check bit does not have a capability of correcting data in which data corruption occurs. However, for example, in a case where the number of bits in which the data corruption occurs is equal or more than a predetermined threshold in step S3 and it is estimated that the data corruption frequently occurs, the information processing apparatus 1 can execute progress suppression processing to suppress a further progress of the data corruption. Therefore, in the next second embodiment, an information processing apparatus that executes such data corruption progress suppression processing will be described as an example.

### Second Embodiment

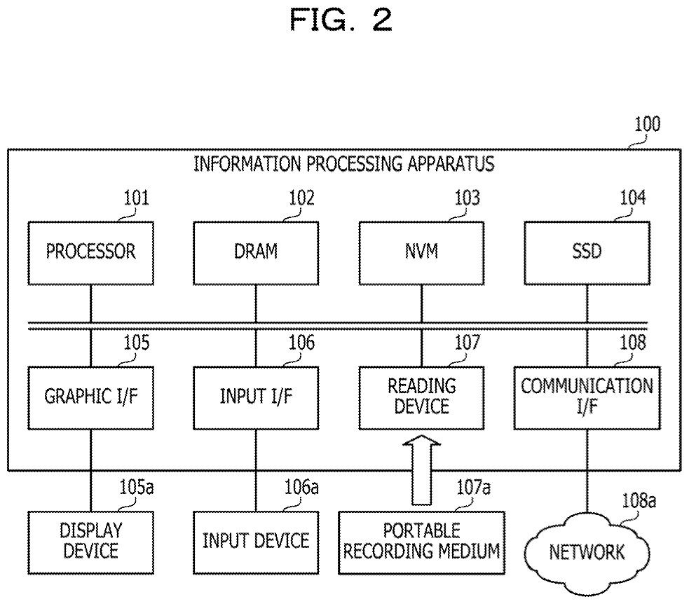

FIG. 2 illustrates an exemplary hardware configuration of an information processing apparatus according to the second embodiment. An information processing apparatus 100 illustrated in FIG. 2 includes a processor 101, a Dynamic RAM (DRAM) 102, a Non-Volatile Memory (NVM) 103, a Solid State Drive (SSD) 104, a graphic interface (I/F) 105, an input interface (I/F) 106, a reading device 107, and a communication interface (I/F) 108.

The processor 101 integrally controls the entire information processing apparatus 100. The processor 101 is, for example, a Central Processing Unit (CPU), a Micro Processing Unit (MPU), a Digital Signal Processor (DSP), an Application Specific Integrated Circuit (ASIC), or a Programmable Logic Device (PLD). Furthermore, the processor 101 may be a combination of two or more elements of a CPU, an MPU, a DSP, an ASIC, and a PLD.

The DRAM 102 is used as a main storage device of the information processing apparatus 100. The DRAM 102 temporarily stores at least a part of an Operating System (OS) program and an application program to be executed by the processor 101. Furthermore, the DRAM 102 further stores various data needed for processing by the processor 101.

The NVM 103 is a nonvolatile memory of which an access speed is higher than that of a flash memory included in the SSD 104. The NVM 103 is realized as a nonvolatile memory generally referred to as an SCM, for example, a 3D crosspoint memory, a MRAM, a ReRAM, a PCM, or the like. Note that the NVM 103 is an example of the nonvolatile memory 2 illustrated in FIG. 1.

In the present embodiment, as an example, both of the DRAM 102 and the NVM 103 are mounted on a memory slot for a main memory (for example, Dual Inline Memory Module (DIMM) slot). Then, a storage region of the NVM 103 is used as a part of a storage region of the main storage device. Alternatively, in a case where a part of the storage region of the DRAM 102 is used as a primary cache, the storage region of the NVM 103 is used as a secondary cache.

The SSD 104 is used as an auxiliary storage device of the information processing apparatus 100. The SSD 104 stores an OS program, an application program, and various data. Note that as an auxiliary storage device, for example, a Hard Disk Drive (HDD) can be used.

The graphic interface 105 is connected to a display device 105a. The graphic interface 105 displays an image on the display device 105a according to a command from the processor 101. Examples of the display device include a liquid crystal display, an organic ElectroLuminescence (EL) display, or the like.

The input interface 106 is connected to an input device 106a. The input interface 106 transmits a signal output from the input device 106a to the processor 101. Examples of the input device 106a include a keyboard, a pointing device, and the like. Examples of the pointing device include a mouse, a touch panel, a tablet, a touch pad, a track ball, and the like.

A portable recording medium 107a is attached to and detached from the reading device 107. The reading device 107 reads data recorded on the portable recording medium 107a and transmits the data to the processor 101. Examples of the portable recording medium 107a include an optical disc, a magneto-optical disc, a semiconductor memory, and the like.

The communication interface 108 exchanges data with another device via a network 108a.

A processing function of the information processing apparatus 100 can be realized by the hardware configuration described above.

By the way, as described above, the storage region of the NVM 103 is used as a part of the storage region of the main storage device or the secondary cache. Therefore, the NVM 103 is requested to perform access at significantly higher speed than that of the flash memory of the SSD 104, and it is desirable for the NVM 103 to have an access speed close to that of the DRAM 102. However, the access speed of the NVM 103 does not reach that of the DRAM 102 mainly for the following two reasons.

One reason is a point that an access speed of a device is simply lower than that of the DRAM 102. Another reason is that it is found that there is a case where a data holding capability of the above SCM used as the NVM 103 is lowered and data corruption (bit inversion error) occurs, and it is needed to take measures against the data corruption. For example, when the ECC is used for the countermeasures against the data corruption, due to calculation of the ECC and error detection and correction processing by using the ECC, a writing speed to the NVM 103 and a reading speed from the NVM 103 are lowered.

Therefore, in the present embodiment, as in a case of the nonvolatile memory 2 indicated in the first embodiment described above, the check bit is written to the NVM 103. In the present embodiment, a page is used as the unit storage region of the NVM 103, and a plurality of check bits is written at the time of data writing to each page. Then, the check bit is read for each page, and the number of bits in which the data corruption occurs is counted. From a rate of the number of bits in which the data corruption occurs with respect to the total number of the check bits read from the page, a rate of the number of bits in which the data corruption occurs (error rate) in the entire page is estimated.

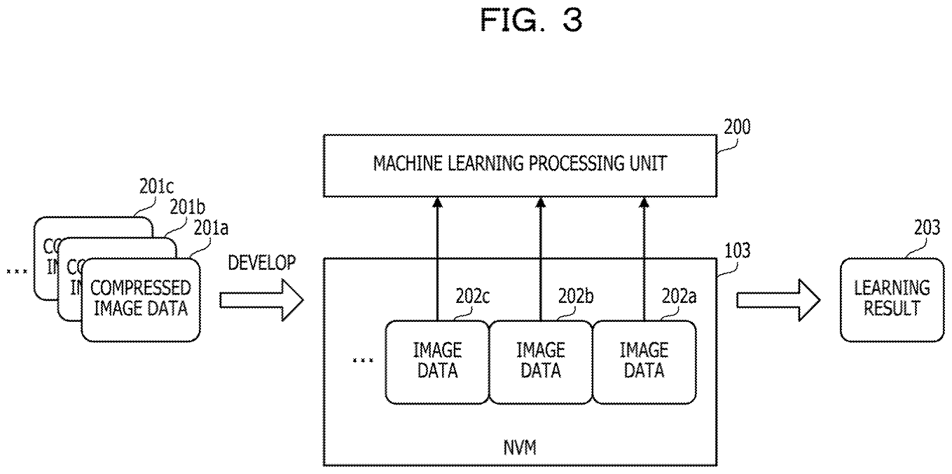

In the present embodiment, when the check bits are read from a single page, in a case where the rate of the bits in which the data corruption occurs with respect to the total number of the check bits is equal to or more than a predetermined threshold, data corruption progress suppression processing is executed on the page. The progress suppression processing is basically processing for suppression of further progress of the data corruption (not to increase in the number of bits in which data corruption occurs from current state) regarding actual data other than the check bits in the page. Therefore, the progress suppression processing is not basically able to correct a value of the bit in which the data corruption has already occurred. However, as illustrated in FIG. 3 below, some of processing using the data stored in the NVM 103 allows a certain degree of data corruption. The progress suppression processing according to the present embodiment can be applied to, for example, such processing.

FIG. 3 illustrates an example of a method of using the NVM. FIG. 3 illustrates a case where machine learning is performed by using image data.

In the example in FIG. 3, it is assumed that pieces of compressed image data 201a, 201b, 201c, . . . be input and these pieces of data be developed (expanded and decoded) so as to obtain pieces of image data 202a, 202b, 202c, . . . , respectively. Then, the obtained pieces of image data 202a, 202b, 202c, . . . are stored in the NVM 103.

A machine learning processing unit 200 reads the image data 202a, 202b, 202c, . . . from the NVM 103, performs machine learning by using these pieces of image data 202a, 202b, 202c, . . . as learning data (teacher data), and outputs a learning result 203. For example, machine learning for image recognition processing is performed. Note that processing of the machine learning processing unit 200 may be realized, for example, by executing a predetermined program by the processor 101 or may be realized by a dedicated processing circuit such as a Graphics Processing Unit (GPU).

In such an application, a large amount of data is developed in the NVM 103 and read from the machine learning processing unit 200. Therefore, in order to perform machine learning at high speed, high writing performance and reading performance of the NVM 103 are requested. On the other hand, even if a certain degree of data corruption occurs in the large amount of learning data such as the image data 202a, 202b, 202c, . . . , this has a small effect on accuracy of the learning result 203.

Therefore, in such an application, the processing according to the present embodiment of executing the data corruption progress suppression processing on the basis of the determination regarding the data corruption occurrence status by using the check bits is preferable. For example, this is because the number of bits in which the data corruption occurs can be suppressed to a certain degree according to the processing of the present embodiment while increasing the reading speed and the writing speed of the NVM 103.

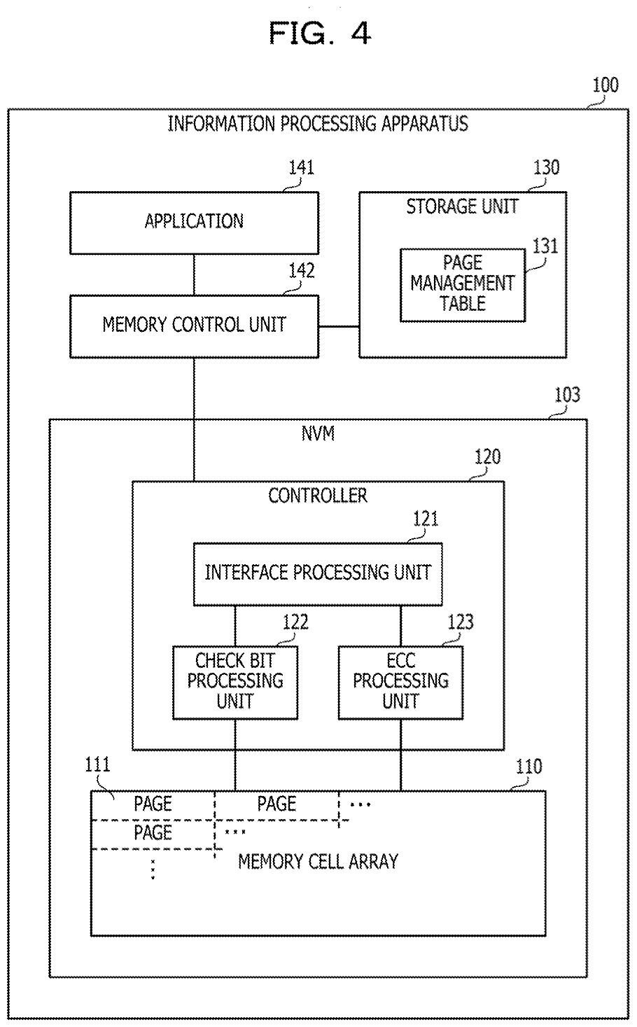

FIG. 4 illustrates an exemplary configuration of processing functions of the Information processing apparatus. Note that, in FIG. 4, a hardware configuration of the NVM 103 is illustrated.

The NVM 103 includes a memory cell array 110 and a controller 120 as hardware. In the memory cell array 110, a large number of memory cells holding data is arranged. Furthermore, the memory cell array 110 is divided into a plurality of pages 111 each of which holds data having a fixed size. A size of the page 111 is, for example, two megabytes. The page 111 is a management unit of writing data, and in the present embodiment, it is determined whether or not it is needed to execute the progress suppression processing of suppressing the progress of the data corruption in units of the page 111.

The controller 120 is a control circuit that controls reading and writing of the data from and to the memory cell array 110. The controller 120 includes an interface processing unit 121, a check bit processing unit 122, and an ECC processing unit 123 as processing functions. At least a part of processing by these processing functions is realized, for example, by executing a predetermined firmware program by a processor included in the controller 120. Furthermore, at least a part of the processing by these processing functions may be executed, for example, by a dedicated hardware circuit included in the controller 120.

The interface processing unit 121 executes interface processing when the processor 101 reads and writes data from and to the memory cell array 110.

The check bit processing unit 122 executes processing regarding the check bit. For example, when writing data to the page 111 of the memory cell array 110 in response to a request from the processor 101, the check bit processing unit 122 writes check bits to a plurality of predetermined positions in the page 111. Furthermore, the check bit processing unit 122 counts the number of check bits, in which the data corruption (bit inversion) occurs, among the check bits read from the page 111.

The ECC processing unit 123 executes processing regarding the ECC. For example, when writing data with the ECC to the memory cell array 110, the ECC processing unit 123 calculates ECC check data on the basis of the data. Furthermore, when reading the data with the ECC from the memory cell array 110, the ECC processing unit 123 executes the error detection and correction processing on the basis of the data and the ECC check data.

By including the check bit processing unit 122 and the ECC processing unit 123 in this way, the NVM 103 can execute both of the processing using the check bit and the processing using the ECC. For example, the processing using the check bit is processing of determining the occurrence status of data corruption in the page 111 by writing the data and the check bit to the page 111 and reading the check bit and determining whether or not to execute the data corruption progress suppression processing. Furthermore, the processing using the ECC is processing of writing the data to the page 111 in a state where the ECC check data is added and detecting and correcting an error by using the ECC check data at the time of reading the data.

Next, the information processing apparatus 100 includes a storage unit 130, an application 141, and a memory control unit 142.

The storage unit 130 is realized by a storage region of a storage device, other than the NVM 103, included in the information processing apparatus 100, for example, the DRAM 102, the SSD 104, or the like. The storage unit 130 stores a page management table 131. The page management table 131 is table information that holds various management information regarding each page 111 of the memory cell array 110. For example, in the page management table 131, information indicating whether or not data writing using the check bit is performed or whether or not data writing using the ECC is performed regarding the above page 111 is registered. Note that the page management table 131 is saved in a nonvolatile storage device (for example, SSD 104) and is loaded to a storage device with higher access speed (for example, DRAM 102) when being used.

Processing of the application 141 and the memory control unit 142 is realized by executing a predetermined program by the processor 101. For example, the processing of the application 141 is realized by executing an application program by the processor 101, and the processing of the memory control unit 142 is realized by executing a driver program of the NVM 103 by the processor 101.

The application 141 executes predetermined processing while using at least the NVM 103 as a work region. It is desirable that the application 141 be processing, such as the machine learning illustrated in FIG. 3, in which data which is allowed to be corrupted at a certain degree exists in data to be processed. In this case, the data which is allowed to be corrupted at a certain degree of the data to be processed is temporarily stored in the NVM 103.

The memory control unit 142 controls access to the NVM 103 in response to a request from the application 141. When writing data to the page 111 in the NVM 103, the memory control unit 142 instructs the controller 120 of the NVM 103 to write the check bits, which are fixed values, at a plurality of positions in the page 111 and to write the data to a remaining region in the page 111.

Furthermore, the memory control unit 142 instructs the controller 120 to read the check bit regarding the page 111 to which the data has been written. In this case, the check bit processing unit 122 of the controller 120 reads the check bits from the page 111 and counts the number of bits in which data corruption occurs among the read check bits. The memory control unit 142 acquires a count value of the number of bits in which data corruption occurs from the controller 120 and determines whether or not to execute the data corruption progress suppression processing. Then, in a case where it is determined that it is needed to execute the progress suppression processing, the memory control unit 142 controls the controller 120 and executes the progress suppression processing.

Note that the processing of the memory control unit 142 may be executed, for example, by the controller 120. Furthermore, for example, at least a part of the processing of the check bit processing unit 122 and the ECC processing unit 123 may be realized by executing a predetermined program by the processor 101.

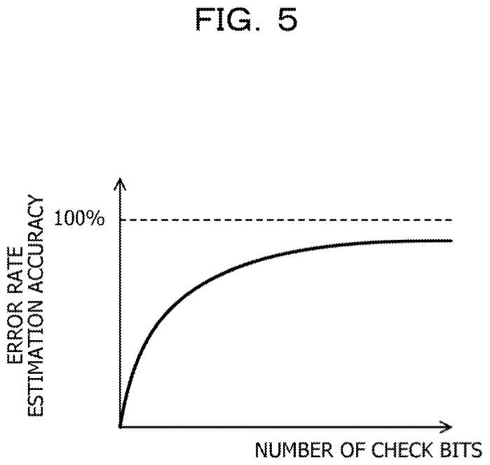

Next, processing of writing the check bit to the page 111 will be described with reference to FIGS. 5, 6A, and 68. In the present embodiment, the number of check bits and a pattern of check bit writing positions can be set for each page 111.

FIG. 5 illustrates an example of a graph indicating a relationship between the number of check bits and error rate estimation accuracy. In FIG. 5, an example of the relationship between the number of check bits and the rate of the error rate estimation accuracy per page 111 is illustrated. The number of check bits to be written to the page 111 will be described with reference to FIG. 5.

There is a case where a sensitivity with respect to the data corruption (data corruption allowable rate) differs according to the data written to the NVM 103 from the application 141 and requested accuracy of error rate estimation differs according to that. On the other hand, as illustrated in FIG. 5, when the number of check bits per page 111 reaches a certain value, the error rate estimation accuracy hardly increases. Therefore, an upper limit of the number of check bits per page 111 can be set to a value at which the error rate estimation accuracy is almost saturated.

In the present embodiment, in view of such characteristics, the number of check bits per page 111 can be arbitrarily or automatically set from a number equal to or less than a predetermined upper limit value. For example, when the application 141 requests the memory control unit 142 to write data, the number of check bits in a write destination page 111 can be specified on the basis of a sensitivity with respect to data corruption regarding data to be written. Alternatively, for each application that writes the data to the NVM 103, the number of check bits per page 111 at the time of the writing may be set in advance.

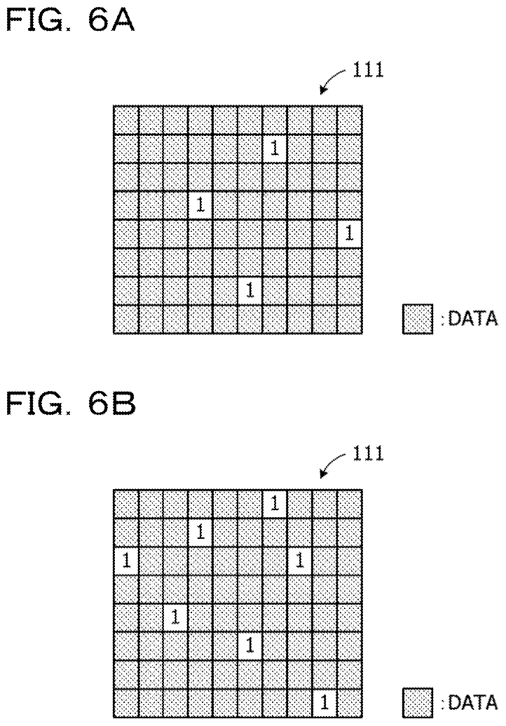

FIGS. 6A and 6B illustrate examples of a position pattern of the check bits. A pattern (position pattern) of check bit writing positions in the page 111 will be described with reference to FIGS. 6A and 6.

There is a case where a region in the page 111 where the data corruption easily occurs differs for each page 111. For example, a case may occur where, although there is a high possibility that data corruption uniformly occurs in one page 111, there is a high possibility that data corruption occurs in a region closer to the head in another page 111. Therefore, as one of the position patterns of the check bits, a pattern in which the check bits are arranged at regular intervals in the page 111 can be applied. Furthermore, as another position pattern, a pattern can be applied in which the check bits are arranged at shorter intervals (higher density) than that in the other region in any one of a head region, a middle region, and an ending region in the page 111.

In a position pattern 1 illustrated in FIG. 6A, the check bits are arranged at regular intervals in the page 111. Furthermore, in a position pattern 2 illustrated in FIG. 68, the check bits are arranged at shorter intervals in the head region from the top to the third row than that in the other regions (middle region and ending region).

When requesting the controller 120 to write data to the page 111, the memory control unit 142 specifies identification information of each of the number of check bits and the position pattern to the controller 120. The check bit processing unit 122 of the controller 120 writes data and check bits to the page 111 on the basis of the specified identification information. For example, the number of check bits and the positions of the check bits written by the check bit processing unit 122 to the page 111 are determined for each combination of the number of check bits and the position pattern.

Furthermore, when writing the data to the page 111, the memory control unit 142 registers a check bit attribute to a record corresponding to a write destination page in the page management table 131. In the check bit attribute, the identification information indicating the number of check bits and the identification information indicating the position pattern are recorded.

Note that the memory control unit 142 specifies the number of check bits and the position pattern regarding the write destination page, for example, according to an instruction from the application 141 as described above. Furthermore, as another example, in a case where it is found that the requested number of check bits and the requested position pattern differ according to the position of the page 111 on the memory cell array 110, the memory control unit 142 may specify the number of check bits and the position pattern according to the position of the write destination page 111. In this case, the number of check bits and the position pattern may be determined according to the position of the write destination page of the data by the check bit processing unit 122 of the controller 120, instead of being specified by the memory control unit 142.

Next, the data corruption progress suppression processing will be described. In the following description, three progress suppression processing patterns will be exemplified.

<Progress Suppression Processing Pattern 1>

First, a progress suppression processing pattern 1 will be described.

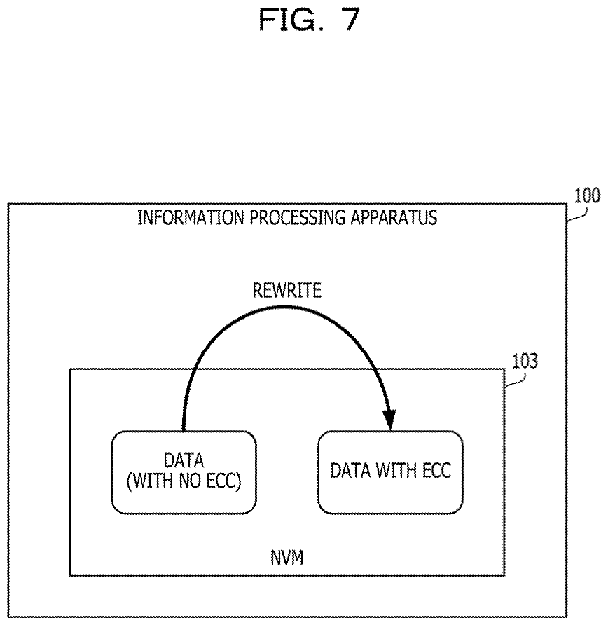

FIG. 7 is a diagram for explaining the progress suppression processing pattern 1. In the progress suppression processing pattern 1, in a case where an estimation value of an error rate (rate of number of bits in which data corruption occurs) regarding the page 111 is equal to or more than a predetermined threshold, the following progress suppression processing is executed.

As illustrated in FIG. 7, the memory control unit 142 instructs the controller 120 to read actual data (data with no ECC) other than the check bits from the page 111, to add the ECC check data to the actual data, and to write the data to another page 111 as data with the ECC. In response to this instruction, in the controller 120, the check bit processing unit 122 reads the data with no ECC from the page 111, and the read data is supplied to the ECC processing unit 123 via the interface processing unit 121. The ECC processing unit 123 calculates the ECC check data on the basis of the supplied data, adds the calculated ECC check data to the supplied data, and writes the data with the ECC to the other page 111 specified by the memory control unit 142. By adding the ECC check data, the data read from the single page 111 is divided and written into the plurality of different pages 111. At this time, an individual ECC check is generated for each write destination page and is written together with the data.

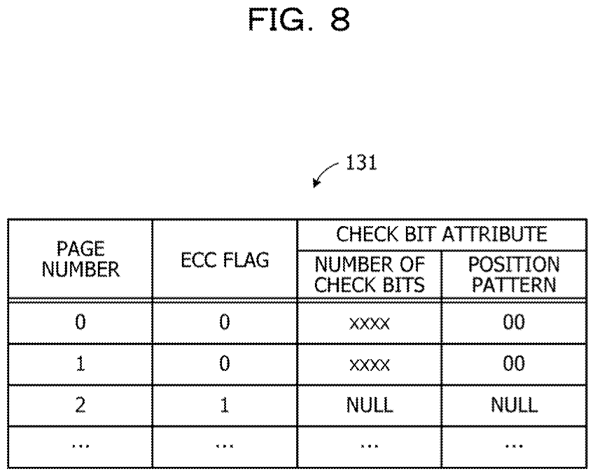

When the above processing is completed, the memory control unit 142 writes information indicating that the data with the ECC has been written to a record corresponding to the page 111, to which the data with the ECC is written, in the page management table 131. For example, as illustrated in FIG. 8 below, an ECC flag in the record is updated from “0” to “1”.

FIG. 8 illustrates an exemplary data configuration of the page management table in a case where the progress suppression processing pattern 1 is adopted. As illustrated in FIG. 8, the page management table 131 includes a record for each page 111 in the memory cell array 110. In each record, a page number used to identify the page 111 is registered. Furthermore, in a case where the progress suppression processing pattern 1 is adopted, the ECC flag and the check bit attribute are registered in each record.

The ECC flag is flag information indicating whether or not the data with no ECC is written to the page 111 or the data with the ECC is written to the page 111. In the present embodiment, in a case where the data with no ECC is written, the ECC flag is set to “0”, and in a case where the data with the ECC is written, the ECC flag is set to “1”. Furthermore, in a state where the data is not written to the page 111, NULL is registered in an item of the ECC flag.

The check bit attribute is registered only in a case where the ECC flag is “0”. As the check bit attribute, the identification information indicating the number of check bits and the identification information indicating the position pattern of the check bits are registered. Note that, in a case where the ECC flag is “1”, NULL is registered in an item of check bit attribute.

In the progress suppression processing pattern 1, in a case where data is read from the page 111 of which the ECC flag is set to “1”, the error detection and correction processing is executed by using the ECC check data added to the data. This increases a possibility that the number of bits in which data corruption occurs in the data in the page 111 can be suppressed in a range that can be corrected by using the ECC check data.

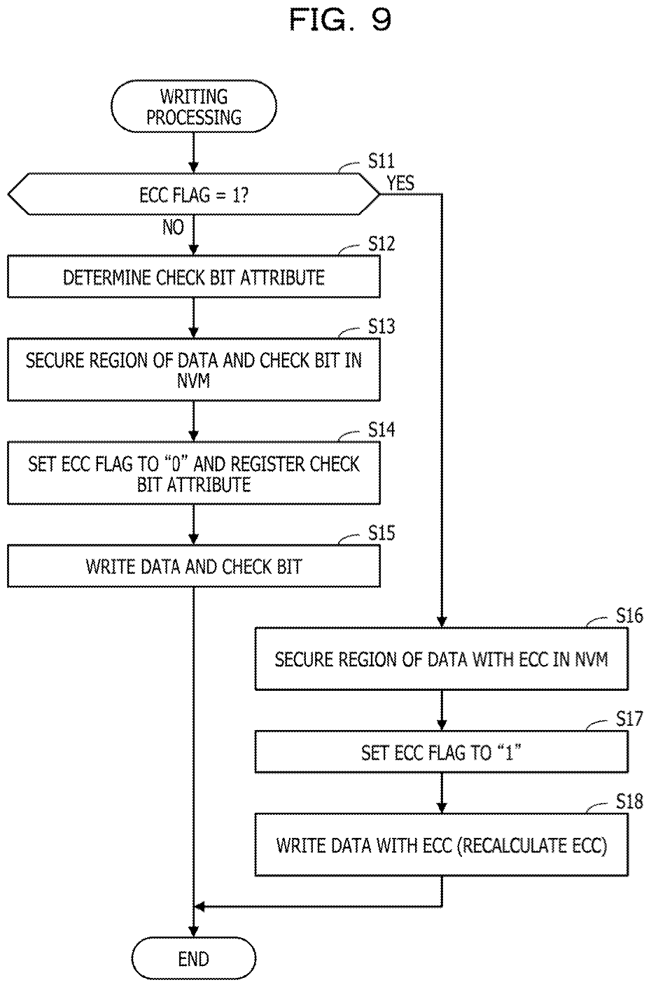

FIG. 9 is an example of a flowchart illustrating a processing procedure of data writing in a case where the progress suppression processing pattern 1 is adopted. The processing in FIG. 9 is started in a case where the memory control unit 142 receives a data writing request from the application 141.

[Step S11] In a case of a new data writing request (not in a case of data update request), the memory control unit 142 proceeds the processing to step S12 with no conditions. Furthermore, in a case of the data update request, the memory control unit 142 reads an ECC flag, corresponding to each page 111 that stores data to be updated, from the page management table 131. In a case where the ECC flag is set to “1”, the memory control unit 142 proceeds the processing to step S16, and in a case where the ECC flag is set to “0”, the memory control unit 142 proceeds the processing to step S12.

Note that, regarding the pages 111 which store the data to be processed, the page 111 of which the ECC flag is set to “0” and the page 111 of which the ECC flag is set to “1” may be mixedly provided. In actual processing, the processing in step S12 and subsequent steps is executed on the page having the ECC flag of “0”, and the processing in step S16 and subsequent steps is executed on the page having the ECC flag of “1”.

[Step S12] The memory control unit 142 determines a check bit attribute (the number of check bits and position pattern) corresponding to a write destination page. For example, the memory control unit 142 determines the check bit attribute on the basis of the specification from the application 141 that is writing request source.

[Step S13] The memory control unit 142 secures a writing region (page 111) for the data and the check bit in the memory cell array 110 of the NVM 103.

[Step S14] The memory control unit 142 specifies a record corresponding to the secured page 111 from the page management table 131. The memory control unit 142 sets the ECC flag to “0” in the specified record and registers information Indicating the content determined in step S12 in the item of the check bit attribute.

[Step S15] The memory control unit 142 instructs the controller 120 to write data with no ECC (data and check bit) to each of the secured pages 111. At this time, the check bit attribute determined in step S12 is specified. In the controller 120, the check bit processing unit 122 writes the check bits, of which the number is according to the check bit attribute, to a position according to the check bit attribute in each of the secured pages 111 and writes the data to a remaining region.

Upon receiving a writing completion notification from the controller 120, the memory control unit 142 issues a response indicating the completion of the writing to the application 141. Furthermore, in a case where data update is requested, for example, the memory control unit 142 invalidates the data of the page 111 in which the data before the update has been written and registers NULL in an item of the ECC flag of the page 111 in the page management table 131.

According to the processing from step S11 (Yes) to the processing in step S15 described above, the calculation of the ECC check data based on the data is not performed, and a check bit, which is a fixed value, is written at a position that has been simply determined in the write destination page together with data. Therefore, as compared with a case where the data with the ECC is written, the writing can be performed at higher speed, and a response time to the writing request can be shortened.

[Step S16] The memory control unit 142 secures a writing region (page 111) for the data with the ECC in the memory cell array 110 of the NVM 103.

[Step S17] The memory control unit 142 specifies a record corresponding to the secured page 111 from the page management table 131. The memory control unit 142 sets an ECC flag of the specified record to “1”.

[Step S18] The memory control unit 142 instructs the controller 120 to write the data with the ECC to each of the secured pages 111. In the controller 120, the ECC processing unit 123 calculates ECC check data on the basis of the data for each write destination page, and the data to which the calculated check data is added is written to the write destination page.

Upon receiving a writing completion notification from the controller 120, the memory control unit 142 issues a response indicating the completion of the writing to the application 141. Furthermore, for example, the memory control unit 142 invalidates the data of the page 111 in which the data before the update has been written and registers NULL in an item of the ECC flag of the page 111 in the page management table 131.

Next, error rate estimation processing by reading the check bit will be described. The error rate estimation processing is executed, for example, at regular intervals for each page in background. Alternatively, a check bit is also read at the time when the data is read from the page 111, and the error rate estimation processing may be executed by using the check bit.

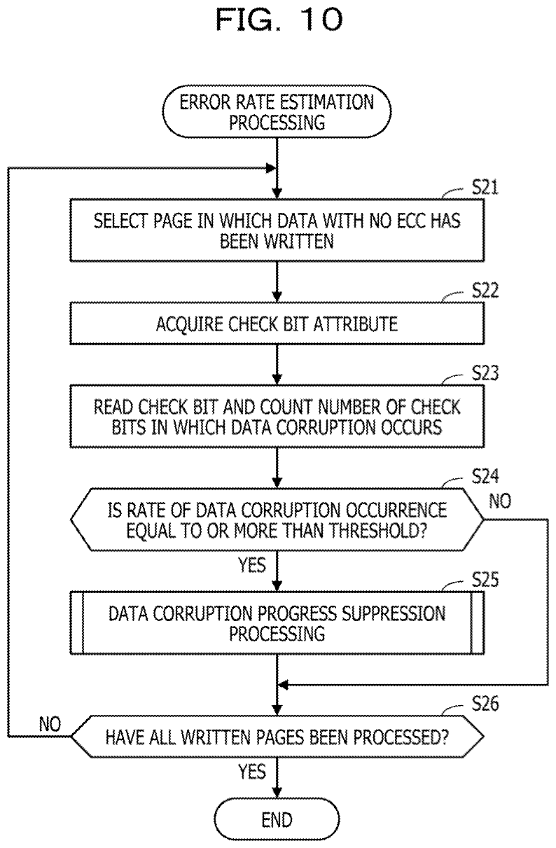

FIG. 10 is an example of a flowchart illustrating an error rate estimation processing procedure in a case where the progress suppression processing pattern 1 is adopted. In FIG. 10, a case where the error rate estimation processing is executed at regular intervals is exemplified. In this case, the processing in FIG. 10 is executed at regular intervals.

[Step S21] The memory control unit 142 selects one page to which the data with no ECC has been written from among the pages 111 of the NVM 103.

[Step S22] The memory control unit 142 acquires a check bit attribute corresponding to the page 111 selected in step S21, from the page management table 131.

[Step S23] The memory control unit 142 instructs the controller 120 to execute processing of reading and counting the check bits from the page 111 selected in step S21. At this time, the check bit attribute acquired in step S22 is specified to the controller 120.

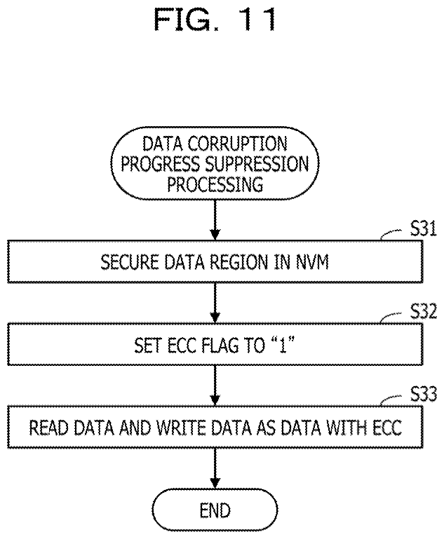

In the controller 120, the check bit processing unit 122 reads check bits from the page 111 on the basis of the specified check bit attribute. The check bit processing unit 122 determines a bit value of each of the read check bits and counts the number of check bits in which data corruption (bit inversion) occurs. According to the count result, the controller 120 notifies the memory control unit 142 of the total number of read check bits and the number of bits in which data corruption occurs.

[Step S24] The memory control unit 142 determines whether or not a rate of the number of bits in which data corruption occurs with respect to the total number of check bits (for example, estimation value of error rate) is equal to or more than a predetermined threshold. In a case where the rate is equal to or more than the threshold, the memory control unit 142 proceeds the processing to step S25, and in a case where the rate is less than the threshold, the memory control unit 142 proceeds the processing to step S26.

[Step S25] The memory control unit 142 executes the data corruption progress suppression processing on the page 111 selected in step S21. Details of processing content in step S25 will be described later with reference to FIG. 11.

[Step S26] The memory control unit 142 determines whether or not all the pages, to which the data with no ECC has been written, have been processed. In a case where there is an unprocessed page to which the data has been written, the memory control unit 142 proceeds the processing to step S21 and continues the processing while selecting one unprocessed page to which the data has been written. On the other hand, in a case where all the pages to which the data has been written have been processed, the memory control unit 142 ends the error rate estimation processing.

FIG. 11 is an example of a flowchart illustrating a procedure of the data corruption progress suppression processing (progress suppression processing pattern 1). The processing in FIG. 11 corresponds to the processing in step S25 in FIG. 10.

[Step S31] The memory control unit 142 secures a writing region (page 111) for the data with the ECC in the memory cell array 110 of the NVM 103.

[Step S32] The memory control unit 142 specifies a record corresponding to the secured page 111 from the page management table 131 and sets an ECC flag of the record to “1”.

[Step S33] The memory control unit 142 instructs the controller 120 to read data from the page 111 selected in step S21 in FIG. 10 and write the read data to the page 111 secured in step S32 as data with the ECC. In the controller 120, the check bit processing unit 122 reads the data from the page 111 selected in step S21, and the data is supplied to the ECC processing unit 123 via the interface processing unit 121. The ECC processing unit 123 calculates ECC check data on the basis of the supplied data, adds the calculated ECC check data to the supplied data, and writes the data to the page 111 secured as a write destination as the data with the ECC.

When the above processing is completed, the memory control unit 142 invalidates the data of the page 111 to which the original data with no ECC has been written and registers NULL to an item of an ECC flag of the page 111 in the page management table 131.

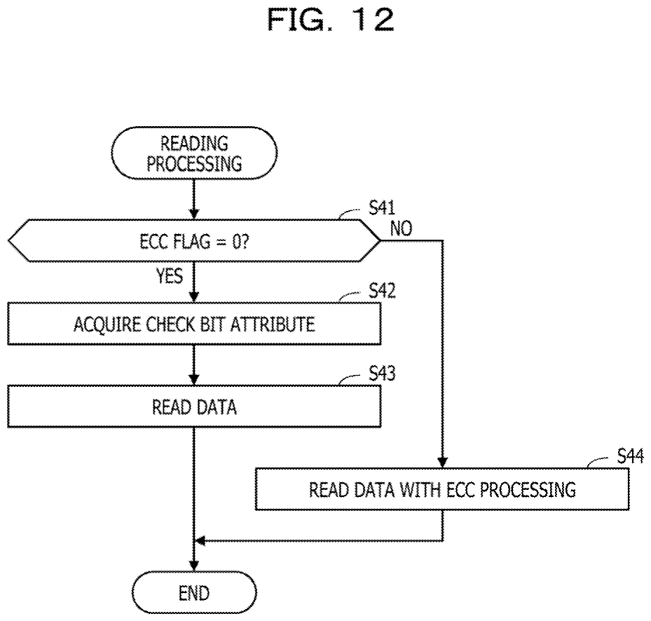

FIG. 12 is an example of a flowchart illustrating a processing procedure of data reading in a case where the progress suppression processing pattern 1 is adopted. The processing in FIG. 12 is executed for each page 111 in a case where the memory control unit 142 receives a data reading request from the application 141.

[Step S41] The memory control unit 142 specifies a record corresponding to the read source page from the page management table 131 and reads an ECC flag from the record. In a case where the ECC flag is set to “0”, the memory control unit 142 proceeds the processing to step S42, and in a case where the ECC flag is set to “1”, the memory control unit 142 proceeds the processing to step S44.

[Step S42] The memory control unit 142 acquires a check bit attribute from the record in the page management table 131 specified in step S41.

[Step S43] The memory control unit 142 instructs the controller 120 to read data from the read source page. At this time, the check bit attribute acquired in step S42 is specified to the controller 120.

In the controller 120, the check bit processing unit 122 reads data except for the check bit from the read source page on the basis of the specified check bit attribute and outputs the read data to the memory control unit 142 via the interface processing unit 121. The memory control unit 142 transfers the output data to the application 141.

[Step S44] The memory control unit 142 instructs the controller 120 to read data with the ECC from the read source page. In the controller 120, the ECC processing unit 123 reads the data with the ECC from the read source page and executes error detection processing by using the data with the ECC. When a bit error is detected, the data is output to the memory control unit 142 via the interface processing unit 121. In a case where bit errors equal to or less than a predetermined upper limit number of bits are detected, the ECC processing unit 123 corrects the error in the data, and the corrected data is output to the memory control unit 142 via the interface processing unit 121. In these cases, the memory control unit 142 transfers the output data to the application 141.

In a case where the progress suppression processing pattern 1 is adopted, as illustrated in FIGS. 7 to 12 described above, the data of the page 111 of which the error rate is equal to or more than the predetermined threshold is rewritten to another page 111 as the data with the ECC. After that, when the rewritten data is read, the error detection and correction processing by using the ECC is executed. Therefore, a possibility such data corruption of the data is progressed can be reduced.

For example, in a case where the progress suppression processing pattern 1 is adopted, it is possible to increase the data writing speed in comparison with a case where the data is written as the data with the ECC. Furthermore, before the error rate becomes equal to or more than the threshold, it is possible to increase the data reading speed in comparison with a case where the data with the ECC is read. Then, while it is possible to obtain such effects of increasing the writing speed and the reading speed, the rate of the number of bits in which data corruption occurs can be suppressed to be equal or less than a certain value with hi probability, and it is possible to maintain reliability of data equal to or higher than a certain level.

Note that, as described above, the reading of the check bits and the error rate estimation processing may be executed along data reading from the page 111. In this case, for example, it is sufficient that the check bit be read together with the data when the data is read in step S43 in FIG. 12 and the processing in steps S22 to S25 in FIG. 10 be executed. The processing in steps S22 to S25 may be executed after a response to the data reading request is output to the application 141. Furthermore, it is not needed to execute the processing in steps S22 to S25 each time when the data is read. For example, whether or not to execute the processing in steps S22 to S25 may be determined when the data is read so as to execute the processing in steps S22 to S25 on the same page 111 at substantially regular time intervals.

<Progress Suppression Processing Pattern 2>

Next, a progress suppression processing pattern 2 will be described.

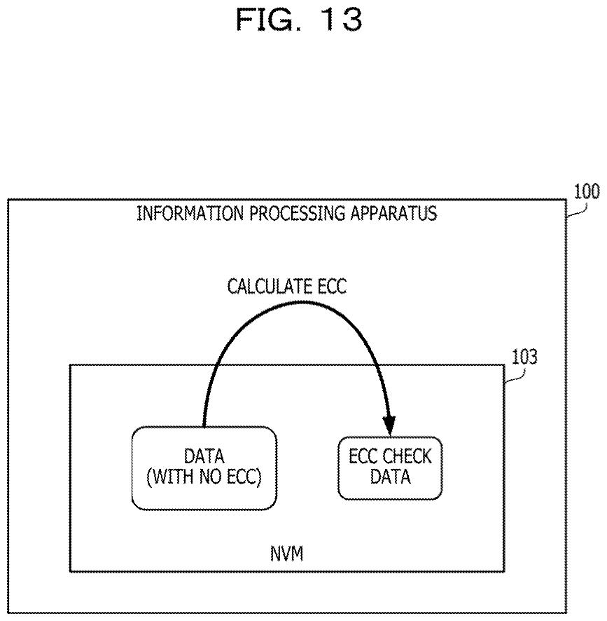

FIG. 13 is a diagram for explaining the progress suppression processing pattern 2. In the progress suppression processing pattern 2, in a case where the estimation value of the error rate regarding the page 111 is equal to or more than a predetermined threshold, the following progress suppression processing is executed.

As illustrated in FIG. 13, the memory control unit 142 instructs the controller 120 to read actual data (data with no ECC) other than check bits from the page 111, calculate ECC check data based on the actual data, and write the calculated data to another page 111. In response to this instruction, in the controller 120, the check bit processing unit 122 reads the data with no ECC from the page 111, and the read data is supplied to the ECC processing unit 123 via the interface processing unit 121. The ECC processing unit 123 calculates ECC check data on the basis of the supplied data and writes the calculated ECC check data to the other page 111 specified by the memory control unit 142.

When the above processing is completed, the memory control unit 142 specifies a record corresponding to original data with no ECC in the page management table 131 and updates an ECC flag in the record from “0” to “1”. At the same time, the memory control unit 142 registers an ECC check data write destination address for the same record.

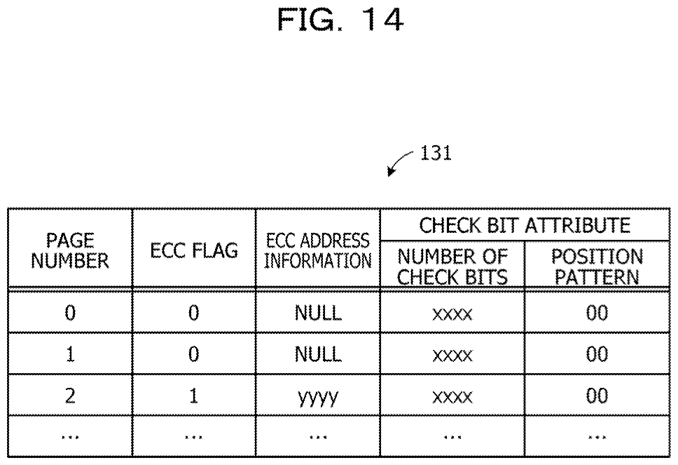

FIG. 14 illustrates an exemplary data configuration of the page management table in a case where the progress suppression processing pattern 2 is adopted. In a case where the progress suppression processing pattern 2 is adopted, in the record for each page 111 of the page management table 131, ECC address information is registered in addition to a page number, an ECC flag, and a check bit attribute.

In the page management table 131, the ECC flag indicates whether or not the ECC check data corresponding to the data written to the page 111 is written to another page 111. In a case where the ECC check data is not written to the other page 111, the ECC flag is set to “0”, and in a case where the ECC check data is written to the other page 111, the ECC flag is set to “1”. Furthermore, in a state where the data is not written to the page 111, NULL is registered in an item of the ECC flag.

The ECC address information is registered only in a case where the ECC flag is “1”. As the ECC address information, information regarding an address (page number and address) where the ECC check data corresponding to the actual data in the page 111 is stored is registered. Note that, in a case where the ECC flag is “0”, NULL is registered in an item of the ECC address information.

In a case where data is read from the page 111 having the ECC flag of “1”, the ECC check data corresponding to the data is read, together with the data requested to be read, on the basis of the ECC address information. Then, the error detection and correction processing is executed on the data by using the ECC check data. This increases a possibility that the number of bits in which data corruption occurs in the data in the page 111 can be suppressed in a range that can be corrected by using the ECC check data.

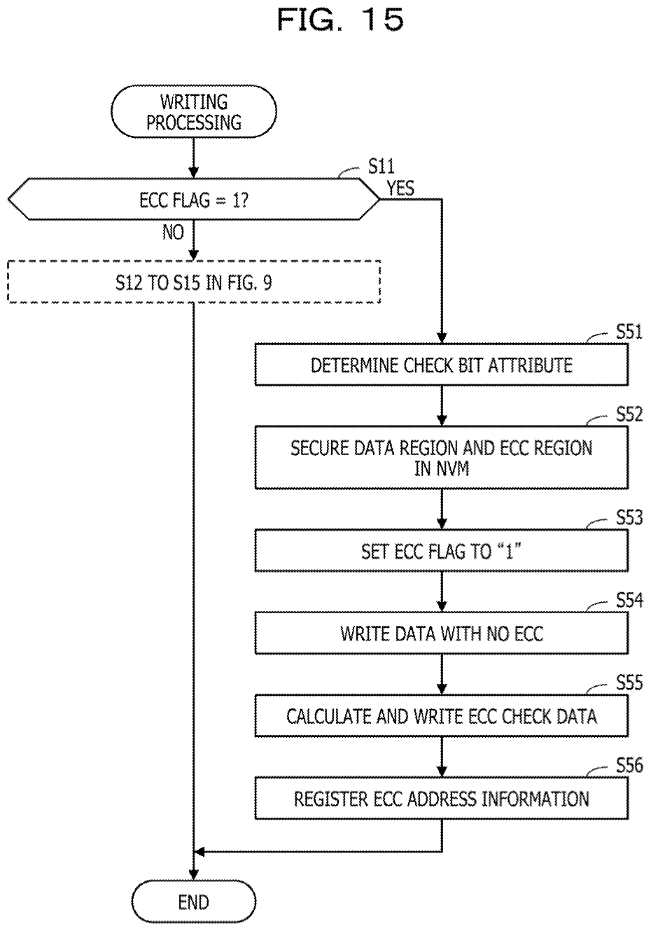

FIG. 15 is an example of a flowchart illustrating a processing procedure of data writing in a case where the progress suppression processing pattern 2 is adopted. In FIG. 15, a processing step in which the same processing as that in FIG. 9 is executed is denoted with the same reference numeral.

In a case where the progress suppression processing pattern 2 is adopted, as in FIG. 9, the determination processing in step S11 is executed. Then, in a case of a new data writing request (not in a case of data update request) and in a case of the data update request and the ECC flag of “0”, the processing in steps S12 to S15 is executed. On the other hand, in a case of the data update request in step S11 and the ECC flag of “1”, the processing proceeds to step S51.

[Step S51] The memory control unit 142 determines a check bit attribute (the number of check bits and position pattern) corresponding to a write destination page by the similar procedure to that in step S12 in FIG. 9.

[Step S52] The memory control unit 142 secures a writing region (page 111) of data and a writing region (region in another page 111) of ECC check data corresponding to the data in the memory cell array 110 of the NVM 103. Note that, in a case where the plurality of pages 111 is secured as the writing region of the data, the same page 111 may be secured as the writing region of the ECC check data corresponding to the data to be written to each page 111.

[Step S53] The memory control unit 142 specifies a record corresponding to the page 111 secured as the writing region of the data from the page management table 131. The memory control unit 142 sets an ECC flag in the specified record to “1”.

[Step S54] The memory control unit 142 instructs the controller 120 to write data with no ECC (data and check bit) to each page secured as the writing region of the data. At this time, the check bit attribute determined in step S51 is specified. In the controller 120, the check bit processing unit 122 writes the check bits, of which the number is according to the check bit attribute, to a position according to the check bit attribute in each of the secured pages 111 and writes the data to a remaining region.

[Step S55] The memory control unit 142 instructs the controller 120 to calculate ECC check data corresponding to the data and write the ECC check data to the page 111 secured as a writing region of the ECC check data. In the controller 120, the ECC processing unit 123 calculates the ECC check data corresponding to each piece of data, and the calculated ECC check data is written to the secured page 111.

[Step S56] The memory control unit 142 registers ECC address information in the record specified in step S53. As the ECC address information, address information indicating the region secured as the writing region of the ECC check data in step S52 is registered.

Furthermore, for example, the memory control unit 142 invalidates the page 111 in which the data before the update has been written and registers NULL in an item of the ECC flag of the page 111 in the page management table 131. Moreover, the memory control unit 142 invalidates, for example, the ECC check data corresponding to data before being updated. When the above processing is completed, the memory control unit 142 issues a response indicating the completion of the writing to the application 141.

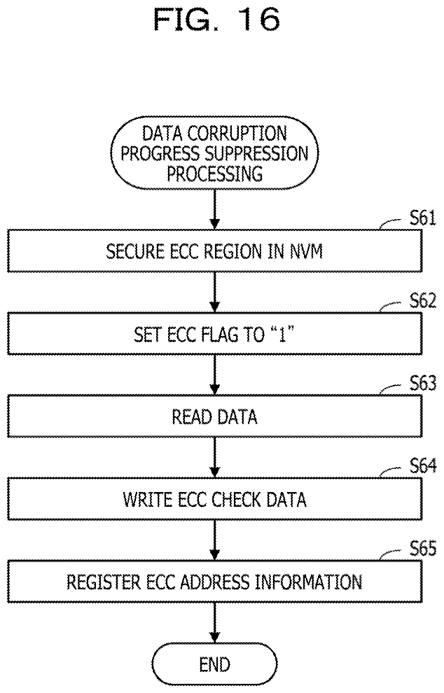

Next, the error rate estimation processing based on the check bit will be described. An overall procedure of the error rate estimation processing in a case where the progress suppression processing pattern 2 is adopted is similar to that in FIG. 10. However, a procedure of the data corruption progress suppression processing in step S25 in FIG. 10 is as in FIG. 16 below.

FIG. 16 is an example of a flowchart illustrating a procedure of the data corruption progress suppression processing (progress suppression processing pattern 2).

[Step S61] The memory control unit 142 secures a writing region (ECC region) of the ECC check data in the memory cell array 110 of the NVM 103. This ECC region is secured in a page 111 different from the page 111 selected in step S21 in FIG. 10.

[Step S62] The memory control unit 142 specifies a record corresponding to the page 111 selected in step S21 in FIG. 10 from the page management table 131 and sets an ECC flag of the record to “1”.

[Step S63] The memory control unit 142 instructs the controller 120 to read the data from the page 111 selected in step S21 in FIG. 10 and write the ECC check data corresponding to the data to the ECC region secured in step S61. In the controller 120, the check bit processing unit 122 reads the data from the page, and the data is supplied to the ECC processing unit 123 via the interface processing unit 121.

[Step S64] The ECC processing unit 123 calculates ECC check data on the basis of the supplied data and writes the calculated ECC check data to the secured ECC region.

[Step S65] The memory control unit 142 registers ECC address information in the record specified in step S53. As the ECC address information, address information indicating the ECC region secured in step S61 is registered.

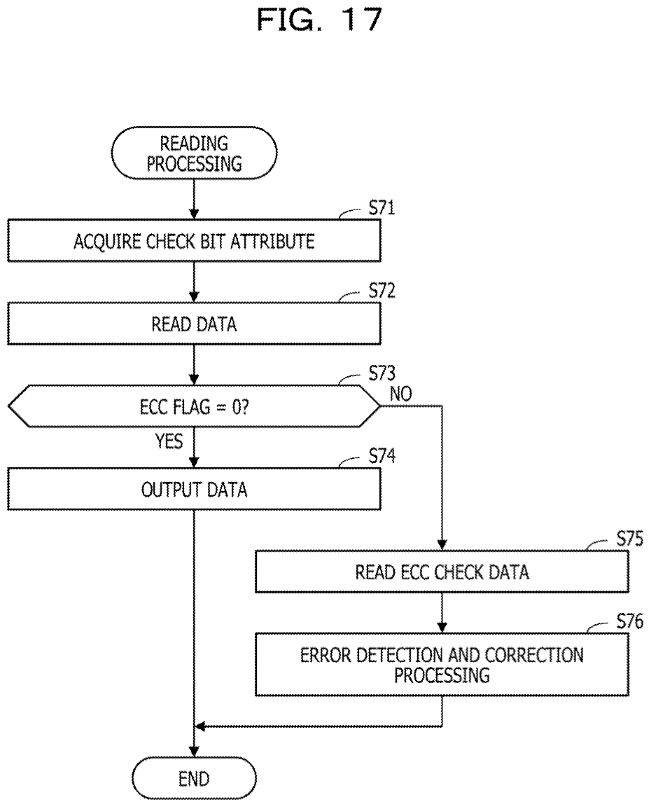

FIG. 17 is an example of a flowchart illustrating a processing procedure of data reading in a case where the progress suppression processing pattern 2 is adopted. The processing in FIG. 17 is executed for each page 111 in a case where the memory control unit 142 receives a data reading request from the application 141.

[Step S71] The memory control unit 142 specifies a record corresponding to a read source page from the page management table 131 and acquires a check bit attribute from the record.

[Step S72] The memory control unit 142 instructs the controller 120 to read data from the read source page. At this time, the check bit attribute acquired in step S42 is specified to the controller 120. In the controller 120, the check bit processing unit 122 reads data except for the check bit from the read source page on the basis of the specified check bit attribute.

[Step S73] The memory control unit 142 reads an ECC flag from the record specified in step S71. In a case where the ECC flag is set to “0”, the memory control unit 142 proceeds the processing to step S74, and in a case where the ECC flag is set to “1”, the memory control unit 142 proceeds the processing to step S75.

[Step S74] The memory control unit 142 outputs the data read in step S72 to the application 141 that is a read request source.

[Step S75] The memory control unit 142 reads the ECC address information from the record specified in step S71. The memory control unit 142 instructs the controller 120 to read the ECC check data from a region indicated by the ECC address information and execute the error detection and correction processing. In the controller 120, the ECC processing unit 123 reads the ECC check data from the region.

[Step S76] The ECC processing unit 123 executes the error detection processing on the data read in step S72 by using the ECC check data read in step S75. When a bit error is detected, the data is output to the memory control unit 142 via the interface processing unit 121. In a case where bit errors equal to or less than a predetermined upper limit number of bits are detected, the ECC processing unit 123 corrects the error in the data, and the corrected data is output to the memory control unit 142 via the interface processing unit 121. In these cases, the memory control unit 142 outputs the output data to the application 141.

As illustrated in FIGS. 13 to 17 above, in a case where the progress suppression processing pattern 2 is adopted, ECC check data corresponding to the data of the page 111 of which the error rate is equal to or more than a predetermined threshold is calculated and stored in the other page 111. After that, when the data is read, the corresponding ECC check data is also read, and the error detection and correction processing is executed on the data. Therefore, a possibility such that data corruption of the data is progressed can be reduced.

For example, in a case where the progress suppression processing pattern 2 is adopted, as in a case of the progress suppression processing pattern 1, it is possible to increase the data writing speed in comparison with a case where the data is written as the data with the ECC. Furthermore, before the error rate becomes equal to or more than the threshold, it is possible to increase the data reading speed in comparison with a case where the data with the ECC is read. Then, while it is possible to obtain such effects of increasing the writing speed and the reading speed, the rate of the number of bits in which data corruption occurs can be suppressed to be equal or less than a certain value with high probability, and it is possible to maintain reliability of data equal to or higher than a certain level.

Note that, as described above, the reading of the check bits and the error rate estimation processing may be executed along data reading from the page 111. In this case, for example, it is sufficient that the check bit be read together with the data when the data is read in step S72 in FIG. 17 and the processing in steps S22 to S25 in FIG. 10 be executed.

<Progress Suppression Processing Pattern 3>

Next, a progress suppression processing pattern 3 will be described.

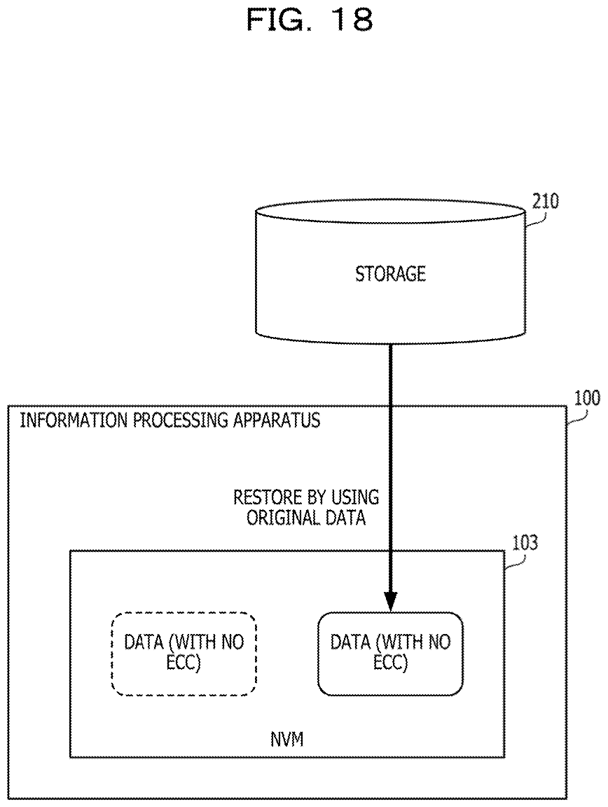

FIG. 18 is a diagram for explaining the progress suppression processing pattern 3. In the above progress suppression processing patterns 1 and 2, in a case where the data corruption occurs in the data in the page 111 of which the error rate is equal to or more than the threshold, the value of the bit in which data corruption occurs has remained uncorrected. On the other hand, in the progress suppression processing pattern 3, in a case where original data corresponding to the data in the page 111 is stored in another storage device, the original data is read from the other storage device and is written to the NVM 103. This makes it possible to restore the data in which data corruption occurs to a state with no data corruption.

In the example in FIG. 18, a case is illustrated where original data in a certain page 111 is stored in a storage 210 connected to outside of the information processing apparatus 100 when the error rate in the page 111 is equal to or more than a threshold. In this case, the memory control unit 142 instructs the controller 120 to read the original data from the storage 210 and write the read original data to the page 111 of which the error rate is equal to or more than the threshold or another page 111. In the controller 120, the check bit processing unit 122 writes the original data to the specified page 111. At this time, a check bit is also written to the write destination page.

A position of the original data is, for example, recognized by the application 141 that is a writing request source to the NVM 103 in many cases. In this case, for example, it is sufficient that the original data be read by the application 141 and transferred to the memory control unit 142.

Note that the processing function of the device (for example, information processing apparatuses 1 and 100) indicated in each embodiment described above can be realized by a computer. In that case, a program describing the processing content of the functions to be held by each apparatus is provided, and the above processing functions are realized on the computer by execution of the program on the computer. The program describing the processing content can be recorded on a computer-readable recording medium. The computer-readable recording medium includes a magnetic storage device, an optical disc, a magneto-optical recording medium, a semiconductor memory, or the like. The magnetic storage device includes a hard disk drive (HDD), a magnetic tape, or the like. The optical disc includes a Compact Disc (CD), a Digital Versatile Disc (DVD), a Blu-ray Disc (BD, registered trademark), or the like. The magneto-optical recording medium includes a Magneto-Optical (MO) disk or the like.

In a case where the program is to be distributed, for example, portable recording media such as DVDs and CDs, in which the program is recorded, are sold. Furthermore, it is possible to store the program in a storage device of a server computer and transfer the program from the server computer to another computer through a network.

The computer that executes the program stores, for example, the program recorded on the portable recording medium or the program transferred from the server computer in its own storage device. Then, the computer reads the program from the storage device of the computer and executes processing according to the program. Note that, the computer can also read the program directly from the portable recording medium and execute processing according to the program. Furthermore, the computer can also sequentially execute processing according to the received program each time when the program is transferred from the server computer connected via the network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a nonvolatile memory having a plurality of unit storage regions; and
a processor coupled to the nonvolatile memory, the processor being configured to:
write a check bit, which is a fixed value, at each of a plurality of positions in a single unit storage region;
write data to be written to a storage region other than the plurality of positions in the single unit storage region when data is written to the single unit storage region of the plurality of unit storage regions;
read the check bits from the single unit storage region; and
determine an occurrence status of data corruption in the single unit storage region on the basis of a bit value of each of the read check bits.

2. The information processing apparatus according to claim 1, wherein
in the determination of the occurrence status, it is determined whether or not to execute progress suppression processing of suppressing progress of the data corruption in the single unit storage region on the basis of a number of inverted bits, in which the bit value is inverted from the fixed value, of the check bits read from the single unit storage region.

3. The information processing apparatus according to claim 2, wherein
the processor is configured to when it is determined to execute the progress suppression processing according to the determination of whether or not to perform the execution, execute control processing, as the progress suppression processing, of performing control, the control processing including:
reading data except for the check bit from the single unit storage region;
adding Error Checking and Correction (ECC) check data based on the read data to the read data; and
rewriting the data to the nonvolatile memory.

4. The information processing apparatus according to claim 2, wherein
the processor is configured to when it is determined to execute the progress suppression processing according to the determination of whether or not to perform the execution, execute control processing, as the progress suppression processing, of performing control, the control processing including:
reading data except for the check bit from the single unit storage region; and
storing ECC check data based on the read data to another unit storage region other than the single unit storage region of the plurality of unit storage regions.

5. The information processing apparatus according to claim 4, further comprising a storage device, wherein
the progress suppression processing further includes processing of recording address information indicating a position where the ECC check data is stored in the storage device, and
the processor is configured to:
perform control to read the ECC check data from the other unit storage region on the basis of the address information when the data is read from the single unit storage region after the execution of the progress suppression processing; and
execute error detection and correction processing on the data read from the single unit storage region on the basis of the read ECC check data.

6. The information processing apparatus according to claim 2, wherein
the processor is configured to when it is determined to execute the progress suppression processing according to the determination of whether or not to perform the execution, execute processing of reading written original data, written in the single unit storage region, regarding writing data except for the check bit from another storage device, and rewriting the read data to the nonvolatile memory, as the progress suppression processing.

7. The information processing apparatus according to claim 1, further comprising
a storage device configured to store management information indicating the number of written check bits and a write position pattern in the single unit storage region, wherein
the check bit is written to the single unit storage region on the basis of the management information.

8. A memory control device comprising
a processor circuitry configured to:
write a check bit, which is a fixed value, at each of a plurality of positions in a single unit storage region;
write data to be written to a storage region other than the plurality of positions in the single unit storage region when data is written to the single unit storage region of the plurality of unit storage regions included in a nonvolatile memory;
read the check bits from the single unit storage region; and
determine an occurrence status of data corruption in the single unit storage region on the basis of a bit value of each of the read check bits.

9. A non-transitory computer-readable storage medium for storing a memory control program which causes a processor to perform processing, the processing comprising:
writing a check bit, which is a fixed value, at each of a plurality of positions in a single unit storage region;
writing data to be written to a storage region other than the plurality of positions in the single unit storage region when data is written to the single unit storage region of the plurality of unit storage regions included in a nonvolatile memory;
reading the check bits from the single unit storage region; and
determining an occurrence status of data corruption in the single unit storage region on the basis of a bit value of each of the read check bits.
